(19) United States
(12) Patent Application Publication
(10) Pub. No.: US 2012/0245996 A1
(43) Pub. Date: Sep. 27, 2012

(54) SYSTEM AND METHOD FOR INTENT-BASED CONTENT MATCHING

(76) Inventors: Jonathan Mendez, Livingston, NJ (US); Donna Romer, New York, NY (US); Richard Shea, Maynard, MA (US)

(21) Appl. No.: 13/053,961

(22) Filed: Mar. 22, 2011

(51) Int. Cl. G06Q 30/00; G06F 17/30; G06N 5/04

(52) U.S. Cl. 705/14.49; 706/52; 707/749; 707/E17.044

(57) ABSTRACT

A method and system for generating a profile for a web page. The method and system includes extracting one or more phrases associated with one or more referring URLs to the web page and determining a phrase relevance distribution including a phrase relevance probability for each of the one or more extracted phrases. The method and system further includes applying at least one phrase relevance probability in the phrase relevance distribution to social media traffic directed to the web page and generating an inferred phrase relevance probability for the social media traffic based on the application of the at least one phrase relevance probability.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention described herein generally relates to providing advertisements or messages for web pages.

### BACKGROUND OF THE INVENTION

Online advertising companies desire to target their advertising content and online publishers desire to target related content messages to users who visit web pages. Existing techniques for selecting advertising or a publisher's related content messages are based on the content of web pages. However, these existing techniques suffer from certain limitations including a need to revise advertisement selections or publishing pages when there is a change of content on the web pages and a need to guess which content on the web page is of interest to users.

Additionally, users who visit web pages may arrive from different sources, such as from search engines, forums, blogs, social media or social networks, and other web pages through hyperlinks. For example, traffic from social media sites generally allow users to arrive at a web page via a hyperlink previously posted on a social stream. Users who select the link are sent to the web page to view a desired content. In this scenario, advertising companies and publishers have no way to derive explicit visitor intent about the user coming to their site.

Currently in the online advertising industry, existing advertisement methods do not adequately account for different sources of traffic arriving at web pages. There is thus a need to identify the interests and intent of users in visiting web pages and for better selection of advertisements and offers that match the interests and intent of the users.

### SUMMARY OF THE INVENTION

The present invention provides a method and system for generating a profile for a web page. The method according to one embodiment of the present invention includes extracting one or more phrases associated with one or more referring URLs to the web page and determining a phrase relevance distribution including a phrase relevance probability for each of the one or more extracted phrases. The method further comprises applying at least one phrase relevance probability in the phrase relevance distribution to social media traffic directed to the web page and generating an inferred phrase relevance probability for the social media traffic based on the application of the at least one phrase relevance probability.

The method according to the presently claimed invention further comprises retrieving one or more advertisements on the basis of the phrase relevance distribution. The method further comprises storing the phrase relevance distribution in a page intent profile associated with the web page. In one embodiment, the method further comprises matching the phrase relevance distribution with a visitor intent profile. The present method may further comprise updating the page intent profile according to the visitor intent profile.

The method according to one embodiment of the presently claimed invention wherein the page intent profile comprises one or more search terms. The one or more search terms may be weighted on the basis of a phrase uniqueness score. The method further comprises updating the page intent profile in real-time. Additionally, the one or more advertisements may be retrieved in real-time upon a user landing on the web page.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention.

FIG. 2 illustrates a logical flow diagram of a computing system according to an embodiment of the present invention.

FIG. 3 illustrates a flowchart of a method for providing advertisements to a web page according to an embodiment of the present invention.

FIG. 4 illustrates a flow diagram of a method for providing advertisements to a web page according to an embodiment of the present invention.

FIG. 5 illustrates a flow diagram of a method for retrieving analytics data according to an embodiment of the present invention.

FIG. 6 illustrates a flowchart of a method for generating one or more page intent profiles according to an embodiment of the present invention.

FIG. 7 illustrates a flowchart of a method for generating one or more page intent profiles according to another embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

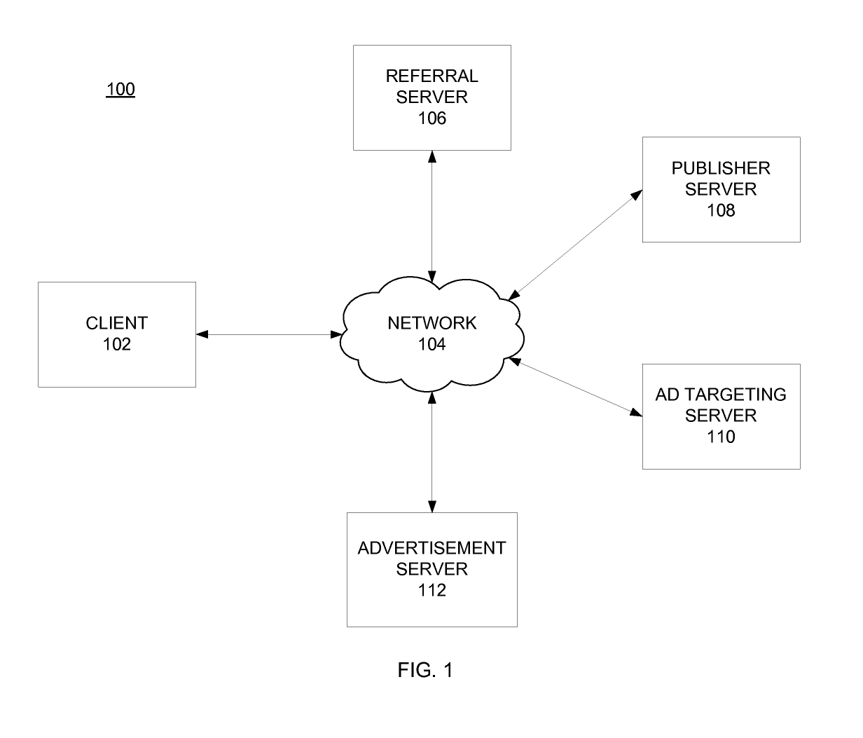

FIG. 1 illustrates one embodiment of a system 100 for providing advertisements to a web page that includes a client 102, network 104, referral server 106, publisher server 108, ad targeting server 110 and advertisement server 112.

Client 102 may comprise a desktop personal computer, workstation, terminal, laptop, personal digital assistant (PDA), cell phone, or any computing device capable of connecting to a network. Client 102 may also comprise a graphical user interface (GUI) or a browser application provided on a display (e.g., monitor screen, LCD or LED display, projector, etc.).

Network 104 may be any suitable type of network allowing transport of data communications across thereof. In one embodiment, the network may be the Internet, following known Internet protocols for data communication, or any other communication network, e.g., any local area network (LAN), or wide area network (WAN) connection.

Referral server 106 may comprise one or more processing components disposed on one or more processing devices or systems in a networked environment. The referral server 106 may operate in a manner similar to known search engine technologies, but with the inclusion of additional processing capabilities described herein. The referral server 106 is operative to receive search requests and process the requests to generate search results to the client 102 across the network 104. In another embodiment, referral server 106 is not limited to providing search operations and may offer or host non-search-related functions, such as providing website content, newsletter content, multimedia content, advertising, social media services, blogs, syndication feeds, forums, instant messages and Short Message Service (SMS) messages.

Content offered by referral server 106 may be provided to users on web pages generated by referral server 106. In one embodiment, web pages or links to web pages may be provided to a user via client 102. A selection of items within the web pages or links to web pages may be entered by a user from client 102 for transmission to the referral server 106, where the referral server 106 may redirect user traffic to publisher server 108. Users redirected to publisher server 108 may arrive on a “landing page.” A landing page may comprise the web page associated with a link from referral server 106 and/or one or more advertisements related to the web page. Publisher server 108 may also be operative to maintain analytical data associated with the traffic it receives from referral server 106. The analytical data of the landing page may either be gathered by publisher server 108 or acquired from a third party service (not illustrated).

In one embodiment, publisher server 108 may provide one or more landing pages with advertisements received from ad targeting server 110. Advertisements may be served by means of communications and requests made between client 102, ad targeting server 110 and advertisement server 112. Examples of advertisement serving companies that may serve advertisements include DoubleClick, Atlas and Mediaplax, etc. In another embodiment, advertisement communications and requests may be established via asynchronous communications allowing retrieval of advertisements without refreshing an entire web page. Ad targeting server 110 is operable to determine and provide the one or more advertisements on the basis of relevance and intent of the user arriving on the landing page provided by publisher server 108.

In another embodiment, referral server 106 may also provide advertisements received from ad targeting server 110 and operate in a manner similar to publisher server 108. Ad targeting server 110 may search and retrieve advertisements deemed relevant and appropriate from advertisement server 112. Advertisement server 112 as illustrated is not limited to one entity and may be a plurality of advertisement servers. In addition to advertisements, embodiments of the present invention may provide any other offers, messages or any targeted content with the landing pages provided by publisher server 108.

Pane Intent Profiles

In one embodiment, ad targeting server 110 may collect analytical data from publisher server 108 through direct analysis of their data or through third party analytics tools or services provided by for example, Google Analytics or Omniture for usage to determine advertisements that are relevant or appropriate. Collecting analytical data from publisher server 108, ad targeting server 110 may include creating what is known herein as a page intent profile of a particular landing page. When search-related traffic arrive from users redirected by referral server, the Hypertext Transfer Protocol (HTTP) header of a search request URL may contain search referral data including the explicit keywords of the users' queries, referral site data, the page-level of the referral site upon redirect.

For example, “www.search.yahoo.com/search;_ylt=movie_times” may indicate a particular query a user has entered into a search engine. Further description and details of keyword extraction from URLs may be found in U.S. Patent Publication No. 2009/0089278 entitled “TECHNIQUES FOR KEYWORD EXTRACTION FROM URLS USING STATISTICAL ANALYSIS” and U.S. Pat. No. 6,882,999 entitled “URL MAPPING METHODS AND SYSTEMS, which are hereby incorporated by reference in its entirety. A publisher may use the search referral data to understand a user's intent for more accurate ad or message targeting. However, such information may be limited to search traffic.

Search traffic is only a portion of network traffic of visitors arriving at landing pages. For example, when considering traffic from social media sites, it is expected that there is a strong likelihood that the intent and areas of interest of users arriving at a given set of pages correlate to the intent and areas of interest of users performing searches that also land on these pages. Therefore, a projection may be made to determine relevant phrase probabilities on the traffic for a given landing page. For a given universal resource locator (URL), relevant phrase probability may be calculated on the basis of the probable number of landings for which a phrase was relevant.

Analytics data from publisher server 108 including search keywords from one or more referring URLs or search referring URLs that bring users to the landing page from a search engine or from the search function within a site hosted on referral server 106 may also be collected. Interest and intent associated with a landing page may also be identified using trend pattern matching and recognition with variable period windows. Trend pattern matching may include analyzing traffic from social media sites as Facebook, Twitter, MySpace, LinkedIn, etc., within a given time period to the landing page. Analysis of social media traffic may include inferring intent and interest by matching baseline probabilities of extracted relevant phrases from search referring URL's with the inferred probability of relevant phrases from social media.

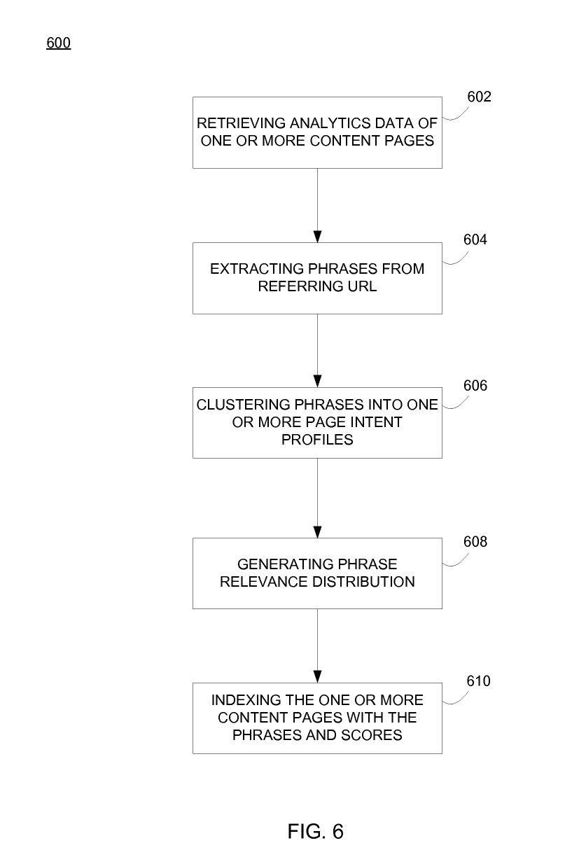

For example, inferring that search users visiting the Long Island Railroad website with the terms “train tickets” extracted from search referring URLs have a 95% interest in train tickets may be used to infer that visitors of social media visiting the same site have a similar probability of interest in train tickets. Relevance probability scores may be calculated for keywords on the basis of the analytics data and the analyzed social media traffic to determine relevant advertising or messages for the landing page. The relevance probability scores may be aggregated into a phrase relevance distribution and stored in the page intent profile. Methods for generating a page intent profile are described in further detail below with respect to the description of FIG. 6. From such data, a page intent profile may be created as an attribute or characteristic of a landing page itself.

Using analytics data from search-based traffic and social media traffic patterns, reliable interest and intent information of users may be determined. Analytics data may be collected from search-related traffic and applied to non-search related traffic by means of the page intent profile. Users redirected from a social site hosted on the referral server 106 to a publisher's landing page can be targeted with a high relevance probability advertisement or message based on the profile of the landing page despite not providing keywords. Page intent profiles focuses on the analysis of how and why users end up at a certain landing page and infers the content of the landing page from this analysis as opposed to directly analyzing the actual content of the landing page. In one embodiment, search terms may also be generated from these inferences. Relevant advertisements and messages may be retrieved on the basis of these inferences using the page intent profiles.

Visitor Intent Profiles

In one embodiment, the user redirected to publisher server 108 may be assigned to a visitor intent profile. Each user visiting a landing page may be assigned a unique visitor ID to associate the user with their particular visitor intent profile. When a user is redirected to a publisher's website from an outside domain (i.e., a “landing”) the unique visitor ID may be assigned to the user for tracking the user and creating a unique visitor intent profile for the user.

A visitor intent profile may include information about users' past and current sessions utilized to determine how to target advertising or messages to them. The visitor intent profile may comprise a group of extracted keywords, pages previously viewed, the order in which the pages were viewed in a session, the classification of viewed pages, time passed since last visit to a given page and the frequency of visits in a given time frame of the given page, either recurring or most recent. Search referral data or site referral semantic URL words may be extracted as well as the time on landing page and geographic location of the user. A referral URL may also be collected to determine a source or type of traffic that a given user came from or the last search the user had performed that led the user to the landing page. A geographical location may be inferred or derived from the IP address of a visiting user.

Match types associated with the extracted keywords (narrow or broad) and weights associated with the match types may be associated with the visitor intent profiles to determine interest and intent. Match types are described in further detail below with respect to the description of FIG. 6. Other data, such as time on page, is added to the visitor intent profile to adjust the weight of various words in their profile. Visitor intent profiles may be stored in a cookie and updated on return visits. In another embodiment, ad targeting system 110 may also build the page intent profiles from information derived from the visitor intent profiles.

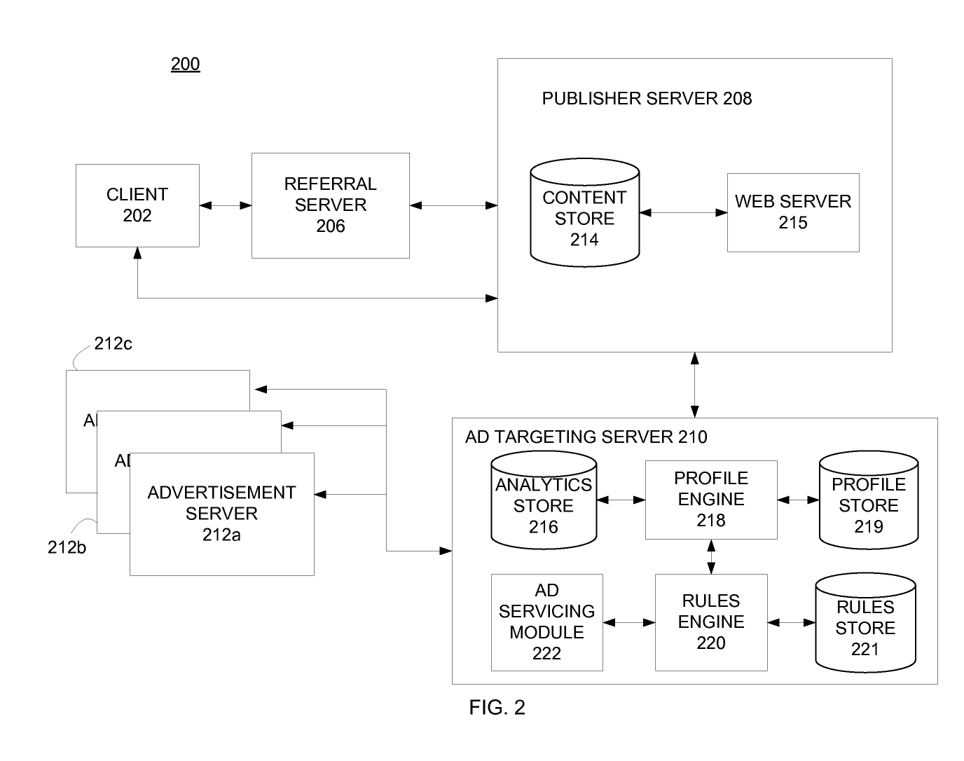

FIG. 2 illustrates in one embodiment, the logical data flow of a system 200 for providing advertisements to a web page. System 200 includes client 202, referral server 206, publisher server 208, ad targeting server 210, advertisement server 212a, 212b and 212c (collectively referred to as 212). Client 202 may retrieve or receive content from referral server 206. Referral server 206 may provide searching services and content. In one embodiment, client 202 may be redirected to or referred to content or services on publisher server 208 from referral server 206 via a referring URL.

Publisher server 208 comprises content store 214 and web server 215. Users redirected from server 206 may land on a content or landing web page provided by publisher server 208. Upon redirection, client 202 may communicate directly with publisher server 208 via web server 215 and may no longer need to communicate with referral server 206. The landing page may be stored and retrieved from content store 214. Web server 215 may retrieve the landing page from content store 214 and provide the landing page to client 202.

Landing pages provided by publisher server 208 may also include advertisements or messages embedded within or associated with the landing pages. In one embodiment, the advertisements or messages may be provided and/or determined by ad targeting server 210.

Ad targeting server 210 comprises analytics store 216, profile engine 218, profile store 219, rules engine 220, rules store 221 and ad servicing module 222. Profile engine 218 may generate page intent profiles for a plurality of landing pages and store the profiles in profile store 219. In one embodiment, ad targeting server 210 retrieves analytics data stored in analytics store 216. The analytics data may be used by profile engine 218 to generate the page intent profiles. Analytics data may include data associated with the user base from publisher 208 and user activity such as search terms from a collection of referring URLs of search traffic and social media traffic directed to the landing pages stored in content store 214 from either third party services (e.g., web analytic providers) or analytics collected by ad targeting server 210. Information in analytics store 216 may include user data from the publisher and Rules engine 220 may generate rules corresponding to the page intent profiles and store the rules in rules store 221.

Advertisements or messages may be delivered with a landing page on the basis of identifying one or more page intent profiles associated with the landing page from profile store 219. In one embodiment, a visitor intent profile may also be identified for client 202. A visitor intent profile for client 202 may be retrieved from user cookies stored on client 202 or visitor intent profiles may be maintained by ad targeting server 210 in profile store 219. Rules corresponding to the one or more identified profiles may be retrieved from rules store 221. The rules retrieved from rules store 221 may be used to determine the advertisements or messages to retrieve for a given landing page associated with the identified profiles. Ad servicing module 222 may receive the rules to fetch advertisements and messages from advertisement server 212 according to the rules. Content fetched from advertisement server 212 include but are not limited to advertisements, publishers' related messages or other types of offers. In one embodiment, the rules may include search terms for querying advertisement server 212. Advertisements and messages retrieved by ad servicing module 222 may be forwarded to client 202 for placement into the landing pages.

In another embodiment, referral server 206 may not redirect a user to publisher server 208. A landing page may be provided by referral server 206. Referral server 206 may include similar components and operate in a similar manner as publisher server 208.

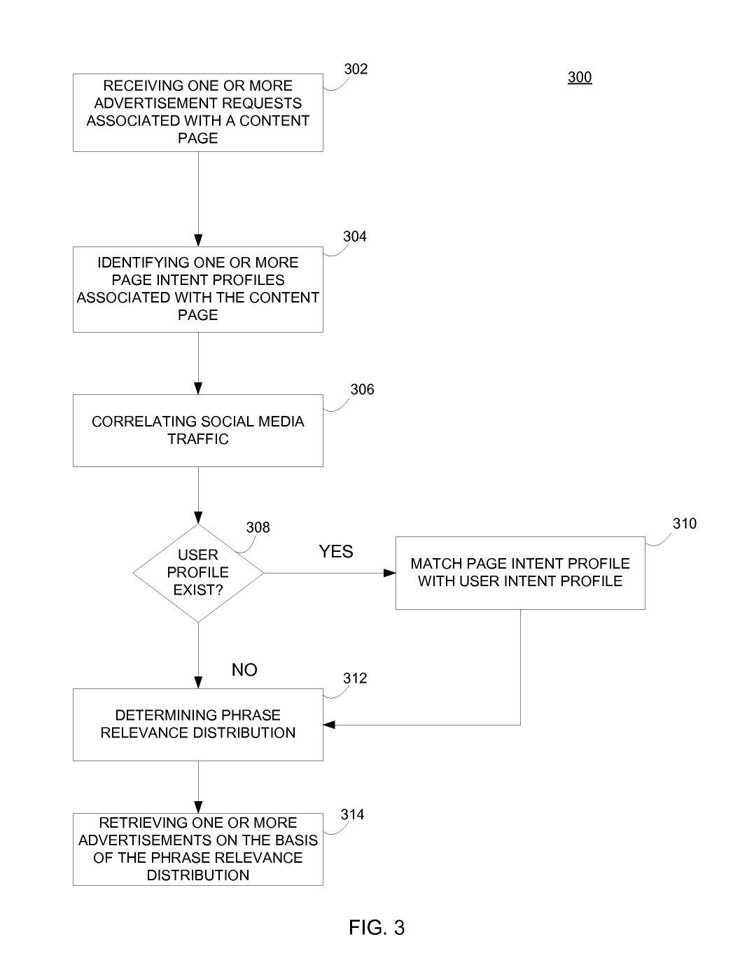

FIG. 3 presents a flowchart of a method 300 for providing advertisements to a web page. The method of FIG. 3 may be executed in the systems of FIGS. 1 and 2 or any other suitable processing environment. One or more advertisement requests associated with a content page are received, step 302. The content page may be a landing page provided by a publisher server. The request may be received from the client requesting to receive an advertisement to provide in conjunction with the content on the landing page.

Page intent profiles may be created in an “offline” manner where search terms from a collection of search referring URLs are extracted and analyzed to generate a page intent profile. In one embodiment a page intent profile associated with the content page may require updating to reflect on-going user activity associated with the content page. This updating is performed continuously or periodically as traffic arrives to the content page where search terms associated with a plurality of search referring URLs may be extracted and combined with information stored in the page intent profiles. Page intent profiles may also be updated with visitor intent profiles for each user landing on the content page in real-time. In the event that updates are required, updates to the page intent profile may be performed in real-time.

One or more page intent profiles associated with the content page are identified, step 304. The URL, title, content, tags, etc. of the content page may be used and matched against information derived about the page (i.e., page intent profile). The page intent profile may include information such as search terms extracted from a collection of one or more referring URLs belonging to the search traffic and phrase relevance scores associated with the extracted keywords. Keywords or phrases may be extracted keywords from one or more referral URLs or other keywords maintained on the page intent profile. In an example, a user may be searching for train tickets in New York. Referring URLs associated with the search may include the phrases “New York,” “tickets” and “train.”

In step 306, social media traffic is correlated. In one embodiment, phrase relevance scores assigned to the plurality of extracted keywords in the page intent profile may be correlated to social network traffic directed to the content page. Traffic may be correlated from one or more disparate social media sites directing a plurality of other visitors to the content page within a certain time frame (e.g., within a certain period from the visitor's landing). For example, traffic from social media sites may arrive on a website for the Long Island Railroad. The interest and intent of arriving traffic on the Long Island Railroad website from a user's search in a certain time window may be inferred to be related to traffic to the Long Island Railroad site from the social media sites, e.g., potential users looking to purchase Long Island Railroad tickets or check train schedules. For example, users visiting the Long Island Railroad website between 3 PM to 10 PM may be interested in purchasing train tickets and viewing a train schedule to get home from work.

A correlation may be matched between the phrase relevant probabilities of the extracted phrases and the social media traffic to weigh the social media traffic according to baseline phrase relevance probabilities. From the page intent profile, interest and intent of users searching for “New York train tickets” may assign weights to corresponding social media traffic of users visiting the Long Island Railroad website. In one embodiment, interest and intent of social network users may be determined by assigning weights to inferred traffic based on the baseline phrase relevance probabilities of extracted search terms of referring URLs. Phrase relevance probabilities for certain phrases may be used to weigh and determine the interest and intent from social media traffic.

Step 308 includes determining whether a visitor intent profile exists for the visitor of the content page. The visitor may be identified by an assigned visitor ID, a username, or IP address, etc. If a profile exists for the user, the page intent profile is matched or correlated with the visitor intent profile, step 310. The visitor intent profile may be used in determining interest and intent of a visiting user. Accordingly, a phrase relevance distribution may be determined for social media traffic, step 312. A phrase distribution may include one or more phrase relevance probabilities of extracted search terms from one or more search referring URLs directed to a given content page. The phrase relevance distribution may be retrieved from a page intent profile and used to weigh social media traffic and the analytics data. Interest and intent of social media users may be determined by assigning weights based on the baseline phrase relevance probabilities of extracted search terms of search referring.

In an example, “train” may have a baseline phrase relevance probability of 50%, “tickets” may be 45% and “New York” may be 5%. These percentages or fractions may represent the total number of searches for the Long Island Railroad website. In another embodiment, search terms extracted from search referring URLs may be concatenated or truncated to create better matching terms. “New York train tickets” may for example, be given a 95% baseline phrase relevance probability. This 95% probability may indicate a high likelihood of interest and intent of users visiting the Long Island Railroad website. Probabilities of concatenated phrases may be determined from a sum from the individual phrases or determined in any manner known to one of skill in the art.

It may be determined that a number of the social media traffic to the Long Island Railroad website is inferred to be related to “New York train tickets.” Accordingly, a baseline phrase relevance probability of 95% for “New York train tickets,” discussed above, may be used to apply a weight to social media traffic arriving on the Long Island Railroad website to reflect a 95% probability of users looking for “New York train tickets.” A higher probability for a given phrase may indicate a higher probability that the given phrase is related to the social media traffic. Conversely, if a 5% relevance probability is associated with searches for “New York train tickets” social media traffic may assign a low weight reflecting a 5% probability of users looking for “New York train tickets.” A phrase relevance distribution may comprise phrase relevance scores or probabilities for a plurality of extracted search keywords or phrases. In another embodiment, when matching the page intent profile with the visitor intent profile, a phrase relevance distribution stored in the page intent profile may also be compared to the visitor intent profile. Weights assigned to social media traffic based on phrase relevance probabilities may be varied based on the visitor intent profile.

Upon determining a phrase relevance distribution for the social media traffic, one or more advertisements may be retrieved on the basis of the phrase relevance distribution, step 314. Retrieving advertisements may include selecting advertisements, publishers' related messages or other offers associated with keywords or phrases with favorable relevance probabilities from the phrase relevance distribution. In one embodiment, advertisements may be retrieved using rules-based searching generated based on the selected keywords and stored in the page intent profiles. Rules for searching advertisements may be stored in and retrieved from the page intent profiles to determine search rules or criteria for retrieving relevant advertisements or messages corresponding to the content page upon a user landing on the content page.

Advertisements and messages may be retrieved and provided to a content page in real time upon landing. In one embodiment, advertisements within the content page may be updated and provided based on real-time information associated with the content page. In another embodiment, advertisement search rules associated with the page intent profile may change upon landing, in-session and exiting the content page.

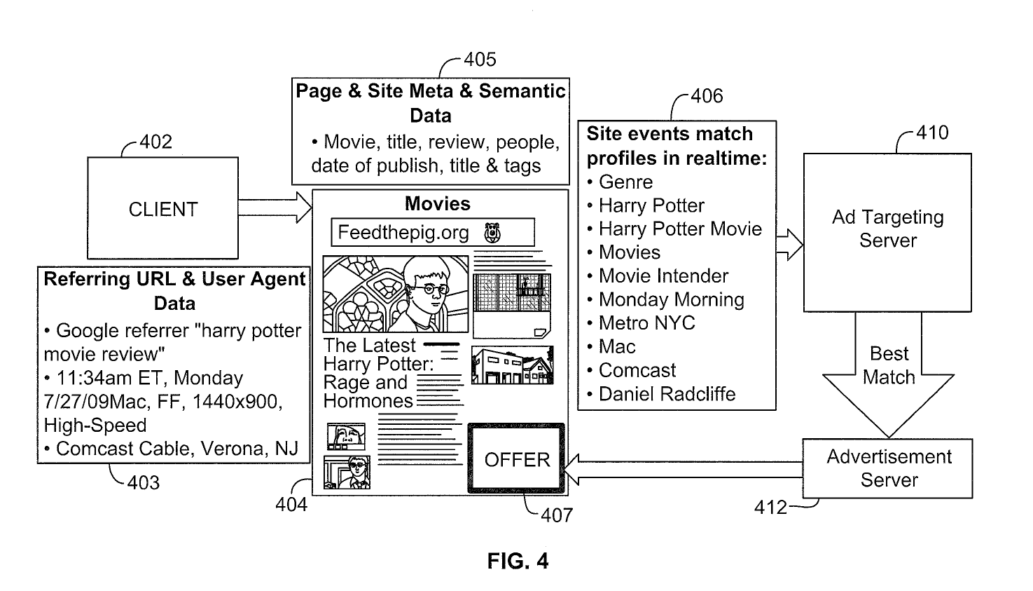

FIG. 4 presents an exemplary flow diagram for providing advertisements to a web page. A user on client 402 arrives at a content page 404 provided by a publisher server. The user may be referred to content page 404 from a referral server (e.g., “Google”) and is associated with analytics data 403 including a search referring URL, search terms (“harry potter movie review”) and user agent information. Page and site data 405 may be used to match to a profile 406 in ad targeting server 410. Advertisements or messages are selected from a best probable match of keywords from advertisement server 412 on the basis of search rules stored in a page intent profile of the content page 404. The search rules may be based on a list of probabilities associated with previous search referring URLs directed to content page 404 or in an alternative embodiment, based on the present URL associated with the user. Advertisements or messages may be retrieved from advertisement server 412 and placed into offer slot 407 on content page 404.

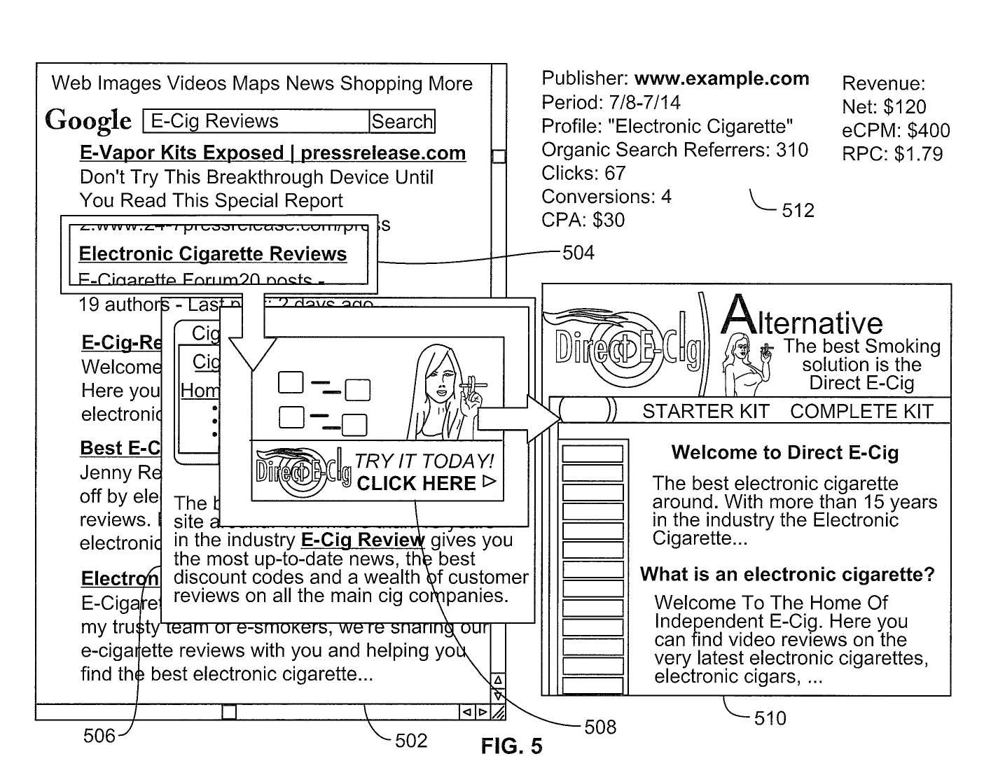

Referring to FIG. 5, the diagram illustrates a referral page 502 providing a user with search results. Search hit 504 refers to a publisher's landing page 506 containing advertisement 508. Clicking on advertisement 508 leads a user to an advertiser's landing page 510. Analytics data 512 shows exemplary information included in an “Electronic Cigarette” profile. The period associated with analytics data 512 may also be used to create a phrase relevance probability which is described in further detail below with respect to the description of FIG. 6. In addition to using analytics data 512 to generate a page intent profile for “example.com”, analytics data 512 may also enable publishers to analyze this information to monetize their traffic from social media or other non-search traffic in the same manner as search advertising.

FIG. 6 presents a flowchart of a method 600 for generating one or more page intent profiles. In step 602, the method includes retrieving analytics data of one or more content pages. Analytics data may be retrieved from an analytics store of an ad targeting server or from a third party provider gathering analytics data of the one or more content pages. The analytics data may include search referring URLs, phrases or search terms associated with the search referring URLs, social media traffic associated with the one or more content pages, total clicks, period of the data, number of search referrers, conversions, cost per acquisition (CPA), effective cost per mile/impression (eCPM), revenue per click (RPC), etc.

Once the analytics data is retrieved, the phrases associated with the referring URLs are extracted from the referring URL, step 604. Extracting the phrases from the referring URL may also include analyzing the phrases to determine a relevance probability for the phrases. The extracted phrases are clustered into one or more page intent profiles, step 606. The extracted phrased may be subjected to language processing to optimize clustering words under a single match, include stop words, stem phrases and consider synonyms. Clustering may also include applying a taxonomy of terms that indicate intent and grouping terms together indicating similar intent. Phrases may be clustered according to correlations between phrases based on their co-occurrence in searches that land on the same URL. These phrases may be semantically dissimilar but they result in users landing on the same URL when searching with these phrases.

Step 608 includes generating a phrase relevance distribution. Generating a phrase relevance distribution may include calculation of phrase relevance probabilities of the analyzed phrases. To calculate a phrase relevance probability, the total search landings may be calculated for each content page URL. The total landings of a given extracted phrase occurring in a search landing may also be calculated and this value is divided by the total searches landing on the URL, which results in the phrase relevance probability for the given extracted phrase. In one embodiment, information such as search keywords and user behavior may be used to generate the phrase relevance probabilities.

In one embodiment, a distribution of traffic hits from several social media sites may be recorded for use in the calculation of the phrase relevance probabilities in the page intent profile. Traffic pattern of the social media sites may be sampled across various time periods and used as analytic data.

A uniqueness score for each search phrase may be used for applying additional weight to phrase relevance probabilities. Common phrases that are associated with a broad range of URLs may be undesirable compared to unique phrases that are associated with a few or narrow set of URLs. The uniqueness score indicates a measure of how broad or narrow the set of URL that are landed by a search containing the given phrase. Additional weight may be assigned to unique terms that arrive on the same pages as common terms.

The one or more content pages are indexed with the clustered phrases and probabilities in the page intent profiles, step 610. Phrases indexed in the page intent profiles may be used to search for advertisements or messages deemed relevant to the content pages associated with the page intent profiles.

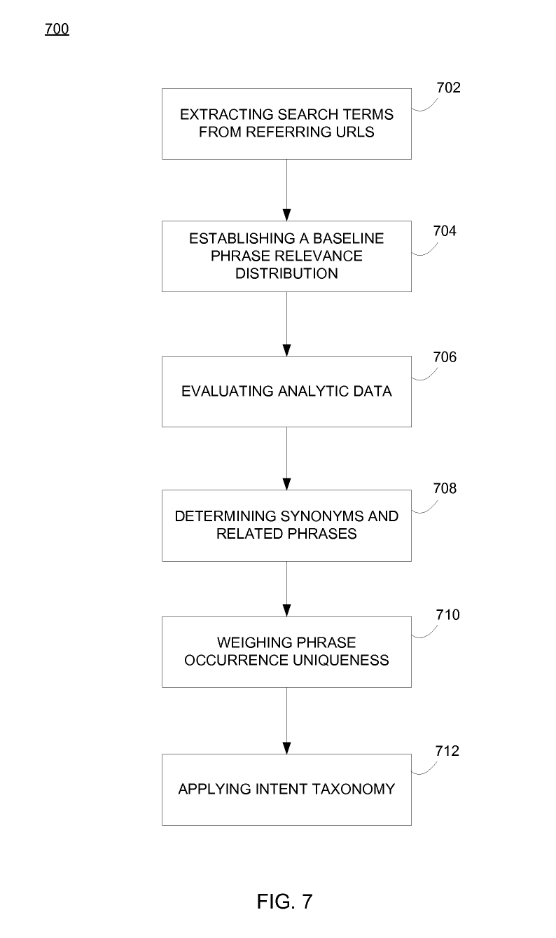

FIG. 7 presents a flowchart of a method 700 for generating one or more page intent profiles and more specifically, generating a relevance distribution of phrase relevance probabilities for one or more content pages. Search terms from search referring URLs directed to a given content page are extracted, step 702. From the example above with reference to FIG. 3, search terms related to “New York,” “train” and “tickets” may be extracted. A baseline phrase relevance distribution is established, step 704. A baseline is established for each page of all the phrases that are contained in the searches that land on the page. For each of the phrases, a fraction of the total search for that page that they are represented in is calculated. For example, “train” may have phrase relevance probabilities of 50%, “tickets” may be 45% and “New York” may be 5% and “New York train tickets” may be given a 95% phrase relevance probability. This fraction may be calculated over any arbitrary time frame.

In step 706, analytic data may be evaluated. In addition to the baseline phrase relevance distribution associated with the extracted terms, analytic data may be used to determine an inferred intent and interest or used as weights to the baseline phrase relevance distribution.

Synonyms and related phrases are determined, step 708. Phrases determined to be related need not be semantically related. Phrases may be correlated via related associations, trend associations and logical associations. For example, an extracted phrase containing “New York train tickets” may not be recognized as related to “Long Island train tickets.” However, Long Island is a location in New York and indeed the two phrases are related. A relationship mapping or association may be created between the two phrases. Step 710 includes weighing phrase occurrence uniqueness. Phrase relevance probabilities for phrases that appear to be unique (e.g., terms found in a small subset of content pages) may be given greater weight than common phrases that appear commonly in search referrer data. Unique phrases may identify a narrow set of content pages or advertising and indicate a more specific intent and interest of a user.

An intent taxonomy is applied, step 712, to the phrase relevance probabilities. Not every extracted phrase may indicate intent. A taxonomy of intent signals may be used to determine an indication of users' intent from the extracted phrases. The taxonomy may include clustering terms into groups indicating intent. The clustered terms may not indicate an intent but may be associated with an intent. For example, “New York train tickets” may not indicate an intent to buy train tickets, buy tickets within New York or look up available train tickets in New York. Each extracted term may be referenced in the taxonomy for assigning weights for the phrase relevance probability associated with the extracted term. In one embodiment, each content page may have a unique intent taxonomy specific to the content page. Each content page may provide different types of content or services related to a common term or subject and may require different intent taxonomies.

A relevance probability distribution may be created and stored in a page intent profile for a given content page. The distribution may include a plurality of relevance probabilities for a plurality of terms extracted from search referring URLs directed to the given content page. Upon a user landing on the given content page, the page intent profile for the content page may be referenced and used to determine the most relevant phrases to use for the retrieval of advertising that most likely matches a user's intent and interest.

For example, the intent and interest of social media users visiting a website such as the Long Island Railroad website may be inferred from the page intent profile. For example, visitors landing on the Long Island Railroad website may be interested in purchasing train tickets. Probable relevant phrase landings may be predicted according to a phrase relevance distribution corresponding to the page intent profile of the Long Island Railroad website. In a given example, a phrase such as “Long Island train tickets” may be an inferred probable phrase for the social media traffic based on the page intent profile.

A projection may be made from baseline phrase relevance probabilities of the phrase relevance distribution for search terms extracted from search referring URLs in the page intent profile to various social media traffic. The projections may be made for probable relevant phrases for social media traffic based on the baseline phrase relevance probabilities. Projections associated with the probable relevant phrases may be used to determine a phrase relevance distribution for the social media traffic. For example, it may be determined that searches related to New York train tickets are a 90% probability according to a baseline phrase relevance for the Long Island Railroad website. A phrase relevance probability of 90% may be generated for “New York train tickets” for the social media traffic may be reflected based on the 90% baseline. A 90% phrase relevance probability may indicate a highly matching criterion and accordingly, advertisements or messages related to the Long Island Railroad website may be retrieved according to “New York train tickets.”

FIGS. 1 through 7 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for generating a profile for a web page, the method comprising:
extracting one or more phrases associated with one or more referring URLs to the web page;
determining a phrase relevance distribution including a phrase relevance probability for each of the one or more extracted phrases;
applying at least one phrase relevance probability in the phrase relevance distribution to social media traffic directed to the web page; and
generating an inferred phrase relevance probability for the social media traffic based on the application of the at least one phrase relevance probability.

2. The method of claim 1 further comprising retrieving one or more advertisements on the basis of the phrase relevance distribution.

3. The method of claim 2 wherein the one or more advertisements are retrieved in real-time upon a user landing on the web page.

4. The method of claim 1 further comprising storing the phrase relevance distribution in a page intent profile associated with the web page.

5. The method of claim 4 further comprising matching the phrase relevance distribution with a visitor intent profile.

6. The method of claim 5 further comprising updating the page intent profile according to the visitor intent profile.

7. The method of claim 4 wherein the page intent profile comprises one or more search terms.

8. The method of claim 7 wherein the one or more search terms are weighted on the basis of a phrase uniqueness score.

9. The method of claim 4 further comprising updating the page intent profile in real-time.

10. A system for generating a profile for a web page, the system comprising:
a computer readable medium having executable instructions stored therein; and
a processing device, in response to the executable instructions, operative to:
extract one or more phrases associated with one or more referring URLs to the web page;
determine a phrase relevance distribution including a phrase relevance probability for each of the one or more extracted phrases;
apply at least one phrase relevance probability in the phrase relevance distribution to social media traffic directed to the web page; and
generate an inferred phrase relevance probability for the social media traffic based on the application of the at least one phrase relevance probability.

11. The system of claim 10 wherein the processing device is further operative to retrieve one or more advertisements on the basis of the phrase relevance distribution.

12. The system of claim 11 wherein the one or more advertisements are retrieved in real-time upon a user landing on the web page.

13. The system of claim 10 further comprising storing the phrase relevance distribution in a page intent profile associated with the web page.

14. The system of claim 13 wherein the processing device is further operative to match the phrase relevance distribution with a visitor intent profile.

15. The system of claim 14 wherein the processing device is further operative to update the page intent profile according to the visitor intent profile.

16. The system of claim 13 wherein the page intent profile comprises one or more search terms.

17. The system of claim 16 wherein the one or more search terms are weighted on the basis of a phrase uniqueness score.

18. The system of claim 13 wherein the processing device is further operative to update the page intent profile in real-time.
